(19) United States
(12) Patent Application Publication
(10) Pub. No.: US 2006/0223921 A1
(43) Pub. Date: Oct. 5, 2006

(54) Prepolymers containing phosphororganic compounds and uses thereof

(76) Inventors: Monika Bauer, Senzig (DE); Berthold Just, Hamburg (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/398,039

(22) Filed: Apr. 5, 2006

(30) Foreign Application Priority Data
Apr. 5, 2005 (DE) DE 102005015605.3

(51) Int. Cl. C08K 5/50

(52) U.S. Cl. 524/121

(57) ABSTRACT

The present invention relates to prepolymers produced by reacting resins with phosphororganic compounds obtained from phosphinic acid derivatives, and their use for producing flame resistant polymers, in particular duromers, and the polymers produced therewith. In particular, the present invention relates to a prepolymer for flame resistant polymers, particularly duromers, which is obtained by reacting at least one phosphinic acid derivative of formula I
(R¹O)(R²)P(O)—R³,
wherein R¹ and R² independently of one another represent an optionally substituted alkyl, aryl, arylalkyl, alkylaryl or alkylarylalkyl group with 1 to 20 carbon atoms,
R³ represents hydrogen or an optionally substituted alkyl, aryl, arylalkyl, alkylaryl or alkylarylalkyl group with 1 to 20 carbon atoms, with at least one resin preferably selected from the group consisting of an epoxy resin, cyanate resin, an unsaturated polyester, vinyl ester, phenol resin and a bismaleimide.

The present invention relates to prepolymers produced by reacting resins with phosphororganic compounds obtained from phosphinic acid derivatives, and their use for producing flame resistant polymers, in particular duromers, and the polymers produced therewith.

The use of phosphinic acid derivatives as flame retardants for resins, in particular epoxy resins, is already principally known. Thus, EP 0 799 847 describes phosphorous-modified epoxy resin mixtures of epoxy resins, a specific phosphinate compound and a curing agent, which exhibit flame retarding characteristics. The German patent application DE 196 19 095 discloses derivatives of 4-hydroxy-1,3-butadiene-1-phosphinic acid and its intramolecular ester, respectively, as flame retardants for epoxy resins. The still unpublished German patent application DE 103 59 269.5 describes the use of hydroxyl groups containing phosphinates for producing flame retardants that are suitable for embedding into polymers and flame protected polymers produced therewith.

With the phosphinate based flame retardants known in the state of the art, polymeric epoxy resins and other polymers with good flame retarding properties can be produced. However, the phosphinate containing starting compositions used for producing flame resistant polymers according to the state of the art are often difficult to handle (e.g. poor solubility in the resin components, crystallization during storage), and are therefore not well suited or not suited at all for specific fields of application such as adhesives, laminating resins and coatings. Moreover, the monomers in the composition have the tendency to crystallize and remain in the end product in case of incomplete conversion during the polymerization reaction, thus affecting the homogeneity and characteristics of the end product. In addition, the environmental friendliness of these compositions is not optimal as a result of the toxicity potential of the reactive monomers.

Therefore, it was a main object of the present invention to provide improved and more widely applicable compositions for producing flame resistant polymers, particularly duromers. A related, more specific object was to provide compositions for producing flame resistant polymers, particularly duromers, which also present a desired fracture toughness. A further object was the provision of the polymers produced by using the compositions according to the present invention.

According to the invention, it was found that the main object described above can be solved by providing a prepolymer according to claim 1, which was produced by reacting a resin with a phosphinic acid derivative as defined in claim 1. Further, it was found that the toughness of the prepolymer or that of a polymer produced therewith is adjustable by incorporating a toughness modifier into this prepolymer, so that the above additional object of the invention can be achieved with such prepolymer. More specific embodiments of the present invention are object of the dependent claims.

### DESCRIPTION OF THE INVENTION

The present invention relates to a prepolymer for flame resistant polymers, particularly duromers, which is obtained by reacting at least one phosphinic acid derivative of formula I
(R¹O)(R²)P(O)—R³,
wherein R¹ and R² independently represent an optionally substituted alkyl, aryl, arylalkyl, alkylaryl or alkylarylalkyl group with 1 to 20 carbon atoms,
R³ represents hydrogen or an optionally substituted alkyl, aryl, arylalkyl, alkylaryl or alkylarylalkyl group with 1 to 20 carbon atoms,
with at least one resin preferably selected from the group comprising an epoxy resin, cyanate resin, an unsaturated polyester, vinyl ester, phenol resin and a bismaleimide.

According to a preferred embodiment, in the phosphinic acid derivative of formula I, the carbon atoms of the groups represented by R¹ and R² are bonded to one another. In a more specific embodiment thereof, the group (R¹O)(R²)P(O)— represents an intramolecular anhydride of a preferably straight-chain alkane phosphinic acid with a terminal carboxyl group. This alkane phosphinic acid preferably contains a straight chain of 2 to 10 carbon atoms between the phosphorous atom and the terminal carboxyl group. According to a further more specific embodiment, the group (R¹O)(R²)P(O)— represents a derivative of 1:9,10-dihydro-9-oxa-10-phosphaphenanthrene-10-oxide (DOPO).

The above defined group R³ preferably contains at least one functional group which is capable to react with a functional group of the designated resin. This functional group may be, for example, a hydroxyl group, ether group, thioether group, an optionally substituted carboxylic acid group or activated carboxylic acid group (e.g. ester, amide, anhydride, acid chloride), a cyanate group, a maleimide group or another group with a reactive double bond. In the case of R³ equals H (DOPO), the coupling to the resin takes places directly at the phosphorous atom of the phosphinic acid group, while in the case of an intramolecular phosphinic acid anhydride (e.g. of the formula Id below), the reaction takes place at the anhydride group.

Specific but non-limiting examples of suitable phosphinic acid derivatives are the phosphinic acid derivatives of the following structural formulas:

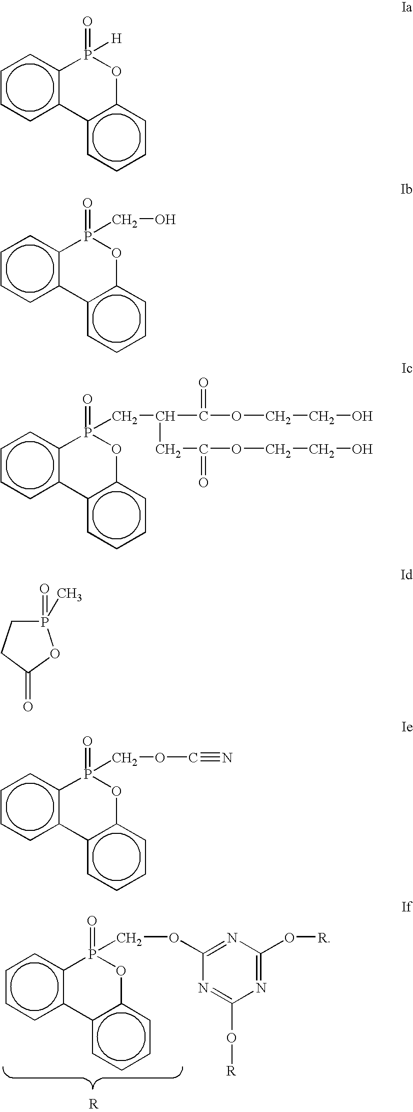

The compounds Ib (DOPOFORM), Ie and If are particularly preferred for producing the prepolymers according to the present invention. The phosphinic acid derivatives of the structural formulas Ie and If (the trimer of formula Ie) are new compounds. The preparation of these compounds is described in examples 22 and 23. The compounds Ic and Id are commercially available as Ukanol DOP (Schill and Seilacher) and PE110 (Clariant), respectively.

The resin monomers may be all resins of the groups mentioned above, which can react with the phosphinic acid derivatives according to the present invention. According to a preferred embodiment, these are epoxy resins. Some suitable, non-limiting examples of such epoxy resins are bisphenol A diglycidyl ether (BADGE), bisphenol F diglycidyl ether (BFDGE), bis(3-glycidyloxypropyl)tetramethyl disiloxane (BGTMSI), triglycidyl-p-aminophenol (TGPAP), cyclohexane-dimethanol diglycidyl ether (Polypox R11), glycerin triglycidyl ether (Polypox R12), neopentyl glycol diglycidyl ether (Polypox R14), pentaerythritol tetraglycidyl ether (Polypox R16), polypropylene glycol diglycidyl ether (Polypox R19), trimethylolpropane triglycidyl ether (Polypox R20) and glycidyl methacrylate (GMA). The Polypox resins used according to the invention were obtained from UPPC AG, and Araldite MY0510 was obtained from Huntsman Advanced Materials. However, analogue resins from other manufacturers can be used as well.

The conversion to the prepolymers according to the invention takes place by reacting under controlled conditions one or more of the resins defined above with one or more of the phosphinic acid derivatives defined above to produce only oligomeric products, while no polymers are created yet. This adjustment is not difficult to accomplish by a person skilled in the art by defining the conventional reaction parameters, e.g. reaction time, reaction temperature, the choice of reaction partners with a desired reactivity, as well as the amount and type of catalyst, if applicable. The present description contains numerous examples for preparing the prepolymers according to the invention, which can be used for orientation purposes.

The reaction is carried out preferably in the presence of a conventional catalyst or accelerator. The catalyst is selected in dependence of the chemical composition of the prepolymer or polymer to be produced and suitable catalysts for a wide spectrum of resins are known to the person skilled in the art.

Some non-limiting examples of catalysts for producing prepolymers containing an epoxy resin are e.g. 3-dimethylamino-1-propylamine (DMAPA), triethanolamine, benzyldimethylamine (BDMA), imidazole and its derivatives, e.g. 2-methylimidazole, 2-phenylimidazole, 2-ethyl-4-methylimidazole, or diazabicycloundecane (DBU) and triphenylphosphine (TPP). Suitable catalyst concentrations are indicated, for example, in Table 2, although they can be varied as required without difficulty by the person skilled in the art.

The following Table 1 provides some examples of DOPO epoxy resins according to the invention and typically applied mole ratios of phosphinic acid derivative to resin components:

TABLE 1

| | OH starting | | Equivalence | |
|---|---|---|---|---|
| — | substance | EP starting substance | ratio OH:EP | Mole ratio |
| DOPO-EP 1 | DOPOFORM | BADGE | 1:2 | 1:1 |
| | | bisphenol A diglycidyl ether | | |
| DOPO-EP 2 | DOPOFORM | BGTMSI | 1:2 | 1:1 |
| | | bis(3-glycidyloxypropyl)tetramethyl disiloxane | | |
| DOPO-EP 3 | DOPOFORM | BFDGE | 1:2 | 1:1 |
| | | bisphenol F diglycidyl ether | | |
| DOPO-EP 4 | DOPOFORM | Araldite MY0510 | 1:3 | 1:1 |
| | | triglycidyl-p-aminophenol | | |
| DOPO-EP 5 | DOPOFORM | Polypox R12 | 1:2 | 3:2 |
| | | glycerin triglycidyl ether | | |
| DOPO-EP 6 | DOPOFORM | Polypox R16 | 1:2 | 2:1 |
| | | pentaerythritol tetraglycidyl ether | | |
| DOPO-EP 7 | DOPOFORM | Polypox R20 | 1:2 | 3:2 |
| | | trimethylolpropane triglycidyl ether | | |
| DOPO-EP 8 | DOPOFORM | Araldite MY0510 | 1:2 | 3:2 |
| | | triglycidyl-p-aminophenol | | |

General synthesis protocol:

The DOPOFORM is dissolved in the EP resin by heating in an oil bath (160-170° C.) with stirring, a clear mixture being obtained after about 30-45 min.

The mixture is removed from the bath, allowed to cool to 125-130° C. under stirring, and the catalyst is added immediately, since the DOPOFORM begins to precipitate (clouding) again after only a few minutes. For example, 5 mol % (calculated relative to the EP groups) DMAPA (3-dimethylamino-1-propylamine) are used as catalyst.

After the exothermic reaction has ceased, the mixture is further heated in the oil bath (see Table 2 for temperature and time). Finally, the prepolymer is poured on aluminum foil and allowed to cool down.

Table 2 lists the reaction conditions and characteristic properties (e.g. Mn, Mw, P content) of different such DOPO epoxy resins.

TABLE 2
Prepolymers

| | | | Reaction | | | |
|---|---|---|---|---|---|---|
| | | | conditions | GPC | | P |
| Composition | Batch No. | Catalyst | (Bath temp.) | Mn | Mw | % |
| 0.01 mol DOPOFORM | G2174/1b | | 4.5 h 170° C. | 607 (THF) | 940 | 5.55 |
| dissolved in | G2231/3 | DMAPA (20 mol % EP) | 1.5 h 170° C. | | | 4.69 |
| 0.01 mol BADGE | G2231/4 | DMAPA (5 mol % EP) | 1 h 170° C. | 662 (THF) | 1310 | 6.1 |
| | | PE110 (15 mol % EP) | | | | |
| | G2235 | DMAPA (5 mol % EP) | 2 h 170° C. | 620 (THF) | 1000 | 4.93 |
| 0.01 mol DOPOFORM | G2174/2b | DMAPA (5 mol % EP) | 4.5 h 170° C. | 558 (THF) | 1000 | 5.55 |
| dissolved in | | | | | | |
| 0.01 mol BGTMSi | | | | | | |
| 0.01 mol DOPOFORM | G2174/3a | DMAPA (5 mol % EP) | 1 h 170° C. | 473 (THF) | 550 | 5.99 |
| dissolved in | | | | | | |
| 0.01 mol BFDGE | | | | | | |
| 0.01 mol DOPOFORM | G2174/4b | DMAPA (5 mol % EP) | 4.5 h 170° C. | 6630 (DMF) | 23000 | 5.91 |
| dissolved in | dd-P155- | DMAPA (5 mol % EP) | 70′ 150° C. | 430 (THF) | 530 | |
| 0.01 mol MY0510 | | | | | | |
| 0.03 mol DOPOFORM | G2193/5 | DMAPA (5 mol % EP) | 2 h 170° C. | 604 (THF) | 810 | 5.65 |
| dissolved in | | | | | | |
| 0.02 mol R12 | | | | | | |
| 0.02 mol DOPOFORM | G2193/6 | DMAPA (5 mol % EP) | 2 h 170° C. | 670 (THF) | 1030 | 5.18 |
| dissolved in | | | | | | |
| 0.01 mol R16 | | | | | | |
| 0.03 mol DOPOFORM | G2193/7 | DMAPA (5 mol % EP) | 2 h 170° C. | 580 (THF) | 780 | 5.65 |
| dissolved in | | | | | | |
| 0.02 mol R20 | | | | | | |
| 0.03 mol DOPOFORM | G2206/1b | DMAPA (5 mol % EP) | 20′ 150° C. | 593 (DMF) | 968 | 6.70 |
| dissolved in 0.02 mol MY0510 | G2206/2a | DMAPA (5 mol % EP) | 1 h 130° C. | 1225 (DMF) | 1455 | |
| | G2206/3a | DMAPA (10 mol % EP) | 1 h 150° C. | 634 (DMF) | 980 | |
| | G2206/3b | DMAPA (5 mol % EP) | 1 h 150° C. | 669 (DMF) | 1230 | |
| | G2206/3c | DMAPA (2.5 mol % EP) | 1 h 150° C. | 601 (DMF) | 951 | |
| | G2206/3d | DMAPA (1 mol % EP) | 1 h 150° C. | 569 (DMF) | 1032 | |
| 1. 0.01 mol DOPOFORM | G2234/2 | DMAPA (20 mol % EP) | 1 h 20 min 170° C. | 582 (DMF) | 6200 | 6.1 |
| dissolved in 3 mmol PE110 | | | | | | |
| 2. +0.01 mol BADGE | | | | | | |
| 1. 0.1 mol DOPOFORM | G2237 | DMAPA (5 mol % EP) | 2 h 170° C. | 563 (THF) | 1070 | 6.02 |
| dissolved in 0.03 mol PE110 | | | | | | |
| 2. +0.1 mol BFDGE | | | | | | |
| 1. 0.05 mol DOPOFORM | G2242 | — | 40 min 170° C. | 426 (THF) | 777 | 8.24 |
| dissolved in 0.05 mol PE110 | | | | | | |
| 2. +0.05 mol BADGE | | | | | | |
| 1. 3 mmol PE110 dissolved | G2233/1 | — | 40 min 140° C. | — | — | 7.15 |
| in 3 mmol BADGE | | | | | | |
| 2. +3 mmol Ukanol RD | | | | | | |
| 1. 3 mmol PE110 dissolved | G2233/2 | TTP (2.5 mol % EP) | 4 h 150° C. | | | 7.15 |
| in 3 mmol Ukanol DOP | | | | | | |
| 2. +3 mmol BADGE | | | | | | |
| 1. 0.015 mol Ukanol DOP | G2239 | — | 10 min 150° C. | 581 (DMF) | 832 | 7.15 |
| dissolved in 0.015 mol PE110 | | | | | | |
| 2. +0.015 mol BADGE | | | | | | |

Catalysts:
DMAPA: 3-dimenthylamino-1-propylamine
TPP: triphenylphosphine

In a preferred embodiment, the prepolymer according to the invention further comprises a toughness modifier component. Particularly preferably, the toughness modifier is incorporated into the prepolymer covalently. Such prepolymers are obtained by simultaneous or stepwise reaction of all three components (resin, phosphinic acid derivative and toughness modifier), optionally in the presence of a catalyst as shown above, for example. Suitable toughness modifiers are, for example, solid rubbers and liquid rubbers, core-shell particles (e.g. Genioperl® from Wacker), thermoplastic silicone elastomers (e.g. Geniomer® from Wacker), elastomers as well as siloxanes and polyethers with functional groups that can react with the resin and/or the phosphinic acid derivative. Nanoparticles can also be used as toughness modifiers. The toughness modifiers can be used both individually and in combination. Some suitable toughness modifier proportions for specific prepolymers are listed in Table 3, although the person skilled in the art can vary them, as necessary, without difficulty, in order to set a specific toughness.

Further, it was surprisingly found that a reaction of the above mentioned toughness modifiers is also possible with phosphinic acid derivatives of formula I without a resin, and that these prepolymers comprising only two components also present advantageous and technically interesting properties.

The prepolymers according to the invention (with or without toughness modifier) have a typical, GPC determined, average molecular weight Mn in the range of from 200 to 10,000 and an average molecular weight Mw in the range of from 400 to 30,000. Preferably, the average molecular weight Mn is in the range of from 300 to 5,000 and the average molecular weight Mw is in the range of from 500 to 15,000.

The phosphorous content of the prepolymers is typically in the range of from 2 to 18%, more frequently in the range of from 4 to 8%. The possibility of attaining a high phosphorous content in the prepolymers according to the present invention increases the application range of the prepolymers, since this allows the production of masterbatches.

Table 3 summarizes the reaction conditions for preparing a series of prepolymers, of which the majority contains a rubber component, and their characteristic properties (e.g. Mn, Mw, P content).

TABLE 3
Prepolymers

| Prepolymer | | | | Reaction | | | |
|---|---|---|---|---|---|---|---|
| | Rubber content | | | conditions | GPC (THF) | | P |
| Synthesis steps | of the prepolymer | Batch No. | Catalyst | (Bath temp.) | Mn | Mw | % |
| 1. Dissolve 10 mmol DOPOFORM in 10 mmol | 15% | G2211/1 | DMAPA | 1 h 170° C. | 298 | 2150 | 4.66 |
| MY510 | 10% | G2211/2 | (5 mol % EP) | 30 min 170° C. | 348 | 593 | 5.05 |
| 2. +CTBNx13 | | | | | | | |
| 1. Dissolve CTBNx13 in 10 mmol R16 | 15% | G2211/4 | | 1 h 170° C. | 300 | 3830 | 4.49 |
| 2. +10 mmol DOPOFORM added | | | | | | | |
| portionwise | | | | | | | |
| 1. Dissolve 5 mmol DOPOFORM in | 15% | G2219/1 | DMAPA | 1 h 150° C. | | | 4.66 |
| CTBNx13 | | | (5 mol % EP) | | | | |
| Dissolve 5 mmol DOPOFORM in 10 mmol | | | | | | | |
| MY510 | | | | | | | |
| 2. EP resin solution added dropwise into | | | | | | | |
| CTBN solution | | | | | | | |
| POLYPOX R16 instead of MY510 | | G2219/2 | | | | | 4.42 |
| 1. ETBN (10 mmol POLYPOX R16 + 0.57 mmol | 15% | G2223/A | DMAPA | 1.4 h 90° C. | 370 | 2740 | 4.58 |
| CTBNx13 + TPP) | | | (5 mol % EP) | | | | |
| 2. +5 mmol DOPOFORM | | G2223/B | TPP | 2.45 min 170° C. | 432 | 3700 | 4.58 |
| | | | (5 mol % EP) | | | | |
| 1. CTBNx13 dissolved in 10 mol BADGE | 15% | G2224/1 | DMAPA | 40 min 170° C. | 515 | 2280 | 4.3 |
| 2. +10 mmol DOPOFORM | | | (5 mol % EP) | | | | |
| 1. CTBNx13 dissolved in 10 mol BFDGE | | G2224/2 | | | 470 | 2520 | 4.7 |
| 2. +10 mmol DOPOFORM | | | | | | | |
| 1. CTBNx13 dissolved in 10 mol R12 | | G2224/3 | | | 517 | 3620 | 4.95 |
| 2. +10 mmol DOPOFORM | | | | | | | |
| 1. CTBNx13 dissolved in 10 mol R20 | | G2224/4 | | | 460 | 2830 | 4.95 |
| 2. +10 mmol DOPOFORM | | | | | | | |
| 1. CTBNx13 dissolved in 10 mol BADGE | 15% | G2225/1 | TPP | 1.5 h 170° C. | 402 | 2070 | 7.2 |
| 2. +10 mmol DOPOFORM added | | | (5 mol % EP) | | | | |
| portionwise | | | | | | | |
| R12 instead of BADGE | | G2225/2 | | | 375 | 2710 | 6.26 |
| R16 instead of BADGE | | G2225/3 | | | 390 | 2850 | 6.26 |
| CY179 instead of BADGE | | G2225/4 | | | 311 | 2030 | 5.8 |
| 1. ETBN (5 mmol BADGE + CTBNx13 + TPP | 15% | G2226/1 | DMAPA | 1.5 h 170° C. | — | — | 5.91 |
| 2. +5 mmol DOPOFORM | | G2226/W | (5 mol % EP) | 3 h 120° C. | 477 | 1150 | |
| | | | | 1 h 140° C. | | | |
| 1. CTBNx13 dissolved in 10 mol BADGE | 15% | G2227/1 | PE110 | 1 h 170° C. | 479 | 2510 | 4.73 |
| 2. +10 mmol DOPOFORM added | | | (5 mol % EP) | | | | |
| portionwise | | | | | | | |
| BFDGE instead of BADGE | | G2227/2 | | | 420 | 2300 | 5.16 |
| 1. CTBNx13 dissolved in 10 mol BADGE | 15% | G2230/1 | DMAPA | 45 min 170° C. | 436 | 955 | 4.3 |
| 2. +10 mmol DOPOFORM added | | G2230/2 | (5 mol % EP) | 2 h 170° C. | 502 | 1130 | 4.3 |
| portionwise | | G2230/3 | DMAPA | 45 min 170° C. | 496 | 1280 | 4.3 |
| | | | 10 mol % EP) | | | | |
| | | G2230/4 | DMAPA, PE110 | 2 × 45 min 170° C. | 551 | 1380 | 4.73 |
| | | | (per 5 mol % EP) | | | | |
| | | G2230/5 | DMAPA, DCC | 45 min 170° C. | 500 | 1290 | 4.3 |
| | | | (per 5 mol % EP) | | | | |
| 1. CTBNx13 dissolved in 10 mol BADGE | 15% | G2231/1 | DMAPA(20 mol % | 2 h 170° C. | | | 4.13 |
| 2. +10 mmol DOPOFORM added | | | EP) | | | | |
| portionwise | | G2231/2 | DMAPA | 2 × 1 h 170° C. | 623 | 1690 | 5.37 |
| | | | (5 mol % EP) | | | | |
| | | | PE110 | | | | |
| | | | (15 mol % EP) | | | | |
| 1. 10 mmol DOPOFORM dissolved in 3 mmol | 15% | G2234/1 | DMAPA | 1 h40 min 170° C. | 797 | 11860 | 5.37 |
| PE110 | | | (20 mol % EP) | | (DMF) | | |
| 2. +10 mmol BADGE +CTBNx13 | | | | | | | |
| 1. 0.1 mol BADGE dissolved in CTBNx13 | 15% | G2236 | DMAPA | 2 h170° C. | 564 | 1360 | 4.3 |
| 2. +0.1 mol DOPOFORM | | | (5 mol % EP) | | | | |
| 1. 0.1 mol DOPOFORM dissolved in 0.03 mol | 15% | G2238 | DMAPA | 2 h170° C. | 565 | 1890 | 5.3 |
| PE110 | | | (5 mol % EP) | | | | |
| 2. +0.1 mol BADGE and CTBNx13 | | | | | | | |
| 1. 0.05 mol DOPOFORM dissolved in | 15% | G2243/W | — | 30 min 170° C.-> | 362 | 433 | 3.67 |
| 0.05 mol PE110 | | | | 130° C. | | | |
| 2. +0.16 mol BADGE and CTBNx13 | | | | | | | |
| 1. NIPOL1472X dissolved in 0.05 mol | 5% | G2247 | DMAPA | 2 h170° C. | | | 4.7 |
| BADGE | | | (5 mol % EP) | | | | |
| 2. +0.05 mol DOPOFORM | | | | | | | |
| 1. 0.05 mol BADGE dissolved in | 15% | G2248 | DMAPA | 2 h170° C. | | | 4.52 |
| CTBNx13 | | | (5 mol % EP) | | | | |
| 2. +0.05 mol Ukanol DOP | | | | | | | |
| 1. 0.04 mol BADGE dissolved in | 15% | G2251 | DMAPA | 2 h170° C. | | | 4.3 |
| CTBNx13 | | | (5 mol % EP) | | | | |
| 2. +0.04 mol DOPOFORM | | | | | | | |
| 1. NIPOL1472X dissolved in 0.05 mol | 5% | G2252 | DMAPA | 2 h170° C. | | | 4.7 |
| BADGE | | | (5 mol % EP) | | | | |
| 2. +0.05 mol DOPOFORM | | | | | | | |

Surprisingly, the prepolymers produced according to the invention generally no longer contain any monomer components and are therefore substantially less toxic and environmentally friendly than the currently known phosphinate containing flame retardant agents. The prepolymers are further also suitable for a wide spectrum of new applications (e.g. as adhesives) and known applications, e.g. production of moulded articles, laminates, prepregs and coatings, wherein the prepolymers according to the invention are further processed to polymers, in particular duromers, with desired properties in regard to flame resistance and toughness.

For the production of a flame resistant polymer according to the invention, a prepolymer according to the invention or a mixture thereof is generally reacted under reaction conditions that lead to further polymerization.

This reaction generally takes place in the presence of a common curing agent. The curing agent is selected in dependence of the chemical composition of the prepolymer or flame resistant polymer to be produced, respectively, and suitable curing agents for a wide spectrum of resins are known to the person skilled in the art. For instance, EP 0 799 847 mentions a plurality of curing agents for epoxy resins. For heat curing, different novolak resins, e.g. phenol, cresol or bisphenol A novolaks, boron trifluoride complexes, acid anhydrides, e.g. hexahydrophthalic acid anhydride, and aromatic amines are utilized. Aliphatic amines cure epoxy resins already at room temperature. Specific, non-limiting examples for suitable curing agents according to the invention, in particular for epoxy resins, are p-xylenediamine and triethylenetetramine (cold curing) as well as dicyandiamide and diaminodiphenyl sulfone (heat curing). The proportion of curing agent may vary widely in dependence of the desired composition and the desired properties of the duromer.

Curing can take place, for example, by means of thermal curing, UV curing or electron beam curing.

The reaction is carried out preferably also in the presence of a conventional catalyst or accelerator. The catalyst is selected in dependence of the chemical composition of the prepolymer or polymer resin to be produced, respectively, and suitable catalysts for a wide spectrum of resins are known to the person skilled in the art.

Some non-limiting examples of suitable catalysts according to the invention, in particular for producing polymer resins containing an epoxy resin, are 3-dimethylamino-1-propylamine (DMAPA), triethanolamine, benzyldimethylamine (BDMA), imidazole and its derivatives, e.g. 2-methylimidazole, 2-phenylimidazole, 2-ethyl-4-methylimidazole, diazabicycloundecane (DBU) and triphenylphosphine (TPP).

In a specific embodiment of the invention, the curing agent and/or catalyst are used in encapsulated form. In this way, the point in time for the curing agent and/or catalyst to participate in the reaction can be adjusted by controlled release thereof from the capsules. If desired, the same principle can be applied in the production of the prepolymers.

Frequently, the reaction will also take place in the presence of a reactive diluent that is incorporated into the polymer. Such reactive diluents for a range of resins are known in the state of the art. For resins on epoxy basis, these are typically mono- to penta-epoxy functional aliphatic, cycloaliphatic or aromatic compounds. Suitable, non-limiting examples for such reactive diluents are bis(3-glycidyloxypropyl)tetramethyl disiloxane, triglycidyl-p-aminophenol, cyclohexanedimethanol diglycidyl ether, glycerin triglycidyl ether, neopentyl glycol diglycidyl ether, pentaerythritol tetraglycidyl ether, polypropylene glycol diglycidyl ether and trimethylolpropane triglycidyl ether.

The phosphorous content of the flame resistant polymers is typically in the range of from 1 to 5%, preferably in the range of from 1 to 3%. Such low phosphorous content generally suffices to impart the polymer sufficient flame resistance.

Table 4 summarizes the reaction conditions for preparing different duromers, and their characteristic properties (e.g. MARHE value, UL94, Tg, P content).

TABLE 4
Duromers

| | | | | | | | | MARHE |
|---|---|---|---|---|---|---|---|---|
| | | | | | | | | (for |
| | | Curing | | K_1C | | Tg (° C.) | | 50 kW/m²) |
| No. | Prepolymer | Agent | Curing | MN/m3/2 | UL94 | DMA | P % | kW/m² |
| G2235 | 0.1 mol DOPOFORM | 6 mass parts | 90° C. 16 h | 0.73 | | 130 | 2.46 | |
| | 0.269 mol BADGE | dicyandiamide | to 2 h 160° C. | | | | | |
| | | 2 mass parts | | | | | | |
| | | UR300 | | | | | | |
| | | (accelerator) | | | | | | |
| G2236 | 0.1 mol DOPOFORM | 6 mass parts | 90° C. 16 h | 0.95 | | 127 | 2.15 | |
| | 0.294 mol BADGE | dicyandiamide | to 2 h 160° C. | | | | | |
| | 7.5% CTBNx13 | 2 mass parts | | | | | | |
| | | UR300 | | | | | | |
| | | (accelerator) | | | | | | |
| G2237 | 0.1 mol DOPOFORM | 6 mass parts | 90° C. 16 h | 0.61 | | 130 | 3.01 | |
| | 0.03 mol PE110 | dicyandiamide | to 2 h 160° C. | | | | | |
| | 0.279 mol BADGE | 2 mass parts | | | | | | |
| | | UR300 | | | | | | |
| | | (accelerator) | | | | | | |
| G2238 | 0.1 mol DOPOFORM | 6 mass parts | 90° C. 16 h | 0.84 | VO | 124 | 2.65 | |
| | 0.03 mol PE110 | dicyandiamide | to 2 h 160° C. | | | | | |
| | 0.304 mol BADGE | 2 mass parts | | | | | | |
| | 7.5% CTBNx13 | UR300 | | | | | | |
| | | (accelerator) | | | | | | |
| G2242 | 0.05 mol DOPOFORM | 6 mass parts | 90° C. 16 h | 0.6 | VO | 124 | 4.12 | |
| | 0.05 mol PE110 | dicyandiamide | to 2 h 160° C. | | | | | |
| | 0.151 mol BADGE | 2 mass parts | | | | | | |
| | | UR300 | | | | | | |
| | | (accelerator) | | | | | | |
| G2243/W | 0.05 mol DOPOFORM | 6 mass parts | 90° C. 16 h | 0.8 | VO | 122 | 3.67 | |
| | 0.05 mol PE110 | dicyandiamide | to 2 h 160° C. | | | | | |
| | 0.16 mol BADGE | 2 mass parts | | | | | | |
| | 7.5% CTBNx13 | UR300 | | | | | | |
| | | (accelerator) | | | | | | |
| G2246/1 | 0.1 mol DOPOFORM | Diaminodiphenyl | 110° C. 6 h | 0.53 | VO | 153 | 2.46 | 222 |
| | 0.269 mol BADGE | sulfone | 4 h 120° C. | | | | | |
| | | EP:NH = 1:1 | to 1 h 180° C. | | | | | |
| G2246/2 | 0.1 mol DOPOFORM | Diaminodiphenyl | 110° C. 6 h | 0.92 | V1 | 153 | 2.15 | 277 |
| | 0.294 mol BADGE | sulfone | 4 h 120° C. | | | | | |
| | 7.5% CTBNx13 | EP:NH = 1:1 | to 1 h 180° C. | | | | | |
| G2247 | 0.05 mol DOPOFORM | Diaminodiphenyl | 110° C. 5 h | 0.8 | VO | 156 | 2.35 | 238 |
| | 0.1375 mol BADGE | sulfone | 3 h 120° C. | | | | | |
| | 2.5% NIPOL1472X | EP:NH = 1:1 | to 1 h 180° C. | | | | | |

Both the prepolymers and the polymers prepared therewith may contain further additives and/or fillers which improve specific properties of the prepolymer or polymers, respectively. Such additives may be, for example, ammonium polyphosphate or aluminum trihydroxide and/or, for example, micro- or nanoparticles made of inorganic materials, such as oxides (e.g. SiO₂, TiO₂, Al₂O₃, ZrO₂), carbides (e.g. SiC), nitrides (e.g. BN), carbon nanotubes, etc.

The following examples are intended to further illustrate the present invention without, however, limiting its scope.

### EXAMPLE 1

### G2211/1: Prepolymer of DOPOFORM, triglycidyl-p-aminophenol (TGPAP/Araldite MY 0510) and Rubber (Hycar 1300×13)

10 mmol DOPOFORM are dissolved in 10 mmol TGPAP in a 25 ml beaker heated in an oil bath (170° C.) with stirring to obtain a clear mixture. 0.974 g (15%) rubber are weighed in and admixed under stirring, the resulting mixture being cloudy. The mixture is left for a further 1 h under stirring, remaining cloudy.

The mixture is removed from the bath. It is left to cool to 125° C., and 1.5 mmol 3-dimethylamino-1-propylamine are then added under vigorous stirring. After the exothermic reaction (temperature increase to 142° C. in the reaction vessel) has ceased, the mixture is further heated in the oil bath (170° C.) for 1 h. The product is cloudy, highly viscous, and hard and brittle at room temperature.

### EXAMPLE 2

### G2211/2: Prepolymer of DOPOFORM, triglycidyl-p-aminophenol (TGPAP/Araldite MY 0510) and Rubber (Hycar 1300×13)

10 mmol DOPOFORM are dissolved in 10 mmol TGPAP in a 25 ml beaker heated in an oil bath (170° C.) with stirring to obtain a clear mixture. 0.614 g (10%) rubber are weighed in and admixed under stirring, the resulting mixture being slightly cloudy. The mixture is left for a further 1 h under stirring, remaining cloudy.

The mixture is removed from the bath. It is left to cool to 125° C. and 1.5 mmol 3-dimethylamino-1-propylamine is then added under vigorous stirring. After the exothermic reaction (temperature increase to 142° C. in the reaction vessel) has ceased, the mixture is further heated in the oil bath (170° C.) for 1 h. The product is cloudy, highly viscous, and hard and brittle at room temperature.

### EXAMPLE 3

### G2211/4: Prepolymer of DOPOFORM, Pentaerythritol Tetraglycidyl Ether (POLYPOX R16) and Rubber (Hycar 1300×13)

0.894 g (15%) rubber are dissolved in 5 mmol R16 in a 25 ml beaker heated in an oil bath (170° C.) with stirring to obtain a clear mixture. 10 mmol DOPOFORM are added portionwise and dissolved. The mixture is slightly cloudy at the end of the addition.

The mixture is removed from the bath. It is left to cool to 135° C. and 1 mmol 3-dimethylamino-1-propylamine is then added under vigorous stirring, which results in increased clouding. The mixture is further heated in the oil bath (160° C.) for 1 h. The product is cloudy, thick-flowing, and still slightly sticky at room temperature.

### EXAMPLE 4

### G2223/4: Prepolymer of Pentaerythritol Tetraglycidyl Ether (POLYPOX R16) and Rubber (Hycar 1300×13), Further Reaction with DOPOFORM

2.5 mmol R16 and 0.447 g (15%) 0.142 mmol rubber are introduced into a 25 ml round-bottom flask. The mixture is heated in an oil bath (90° C.) with stirring under nitrogen, until it is clear. 0.0071 mmol triphenylphosphine (5 mol % of the rubber) are added as catalyst and the reaction mixture is heated for further 4 h.

The bath temperature is increased to 170° C. and 5 mmol DOPOFORM are then added to obtain a clear mixture.

The mixture is removed from the bath. It is left to cool to 145° C. and 0.5 mmol triphenylphosphine are then added under vigorous stirring. The mixture is heated in the oil bath for further 45 min. The product is viscous, and hard and cloudy at room temperature.

### EXAMPLE 5

### G2224/1: Prepolymer of DOPOFORM, Bisphenol A Diglycidyl Ether (BADGE) and Rubber (Hycar 1300×13)

0.926 g (15%) rubber are dissolved in 10 mmol BADGE in a 25 ml beaker heated in an oil bath (170° C.) with stirring to obtain a clear mixture. 10 mmol DOPOFORM are added portionwise and dissolved. The mixture remains clear. The mixture is removed from the bath. It is left to cool to 107° C. and 1 mmol 3-dimethylamino-1-propylamine are then added under vigorous stirring, which results in some clouding. After the exothermic reaction (temperature increase to 117° C. in the reaction vessel) has ceased, the mixture is further heated in the oil bath (170° C.) for 40 min. The product is cloudy, viscous and brittle at room temperature.

### EXAMPLE 6

### G2224/2: Prepolymer of DOPOFORM, Bisphenol F Diglycidyl Ether (BFDGE) and Rubber (Hycar 1300×13)

0.842 g (15%) rubber are dissolved in 10 mmol BFDGE in a 25 ml beaker heated in an oil bath (170° C.) with stirring to obtain a clear mixture. 10 mmol DOPOFORM are added portionwise and dissolved. The mixture remains clear. The mixture is removed from the bath. It is left to cool to 107° C. and 1 mmol 3-dimethylamino-1-propylamine is then added under vigorous stirring, which results in some clouding. After the exothermic reaction (temperature increase to 135° C. in the reaction vessel) has ceased, the mixture is further heated in the oil bath (170° C.) for 40 min. The product is cloudy, viscous and brittle at room temperature.

### EXAMPLE 7

### G2226/W: Prepolymer of Bisphenol A Diglycidyl Ether (BADGE) and Rubber (Hycar 1300×13), Further Reaction with DOPOFORM

5 mmol BADGE and 0.463 g (15%) 0.147 mol rubber are introduced into a 25 ml round-bottom flask. The mixture is heated in an oil bath (90° C.) with stirring under nitrogen, until it is clear. 0.01143 mmol triphenylphosphine (6.6 mol % of the rubber) are added as catalyst and the reaction mixture is heated for further 4 h.

The bath temperature is increased to 170° C. and 5 mmol DOPOFORM are then added to obtain a clear mixture. The mixture is removed from the bath. It is left to cool to 130° C. and 0.5 mmol 3-dimethylamino-1-propylamine are then added under vigorous stirring, which results in clouding of the mixture. The mixture is further heated in the oil bath (120° C.) for 3 h and at 140° C. for 1 h. The product is cloudy, viscous and solid at room temperature.

### EXAMPLE 8

### G2230/3: Prepolymer of DOPOFORM, Bisphenol A Diglycidyl Ether (BADGE) and Rubber (Hycar 1300×13)

0.926 g (15%) rubber are dissolved in 10 mmol BADGE in a 25 ml beaker heated in an oil bath (170° C.) with stirring to obtain a clear mixture. 10 mmol DOPOFORM are added portionwise and dissolved. The mixture remains clear. The mixture is removed from the bath. It is left to cool to 128° C. and 2 mmol 3-dimethylamino-1-propylamine are then added under vigorous stirring, which results in some clouding. After the exothermic reaction (temperature in the reaction vessel increases to 148° C.) has ceased, the mixture is further heated in the oil bath (170° C.) for 40 min. The product is cloudy, viscous, and hard and brittle at room temperature.

### EXAMPLE 9

### G2230/4: Prepolymer of DOPOFORM, Bisphenol A Diglycidyl Ether (BADGE) and Rubber (Hycar 1300×13)

0.926 g (15%) rubber are dissolved in 10 mmol BADGE in a 25 ml beaker heated in an oil bath (170° C.) with stirring to obtain a clear mixture. 10 mmol DOPOFORM are added portionwise and dissolved. The mixture remains clear. The mixture is removed from the bath. It is left to cool to 131° C. and 1 mmol 3-dimethylamino-1-propylamine is then added under vigorous stirring, which results in some clouding of the mixture. After the exothermic reaction (temperature in the reaction vessel increases to 136° C.) has ceased, the mixture is further heated in the oil bath (170° C.) for 50 min. 1 mmol EXOLIT PE110 is added and the mixture is heated for further 50 min. The product is cloudy, highly viscous, and hard and brittle at room temperature.

### EXAMPLE 10

### G2231/4: Prepolymer of DOPOFORM, Bisphenol A Diglycidyl Ether (BADGE)

10 mmol DOPOFORM are dissolved in 10 mmol BADGE in a 25 ml beaker heated in an oil bath (170° C.) with stirring to obtain a clear mixture.

The mixture is removed from the bath. It is left to cool to 126° C. and 1 mmol 3-dimethylamino-1-propylamine is then added under vigorous stirring. After the exothermic reaction (temperature in the reaction vessel increases to 138° C.) has ceased, the mixture is further heated in the oil bath (170° C.) for 1 h. 3 mmol EXOLIT PE110 are added (temperature increase to 178° C.) and the mixture is heated for further 1 h. The product is clear, thick-flowing, and hard and brittle at room temperature.

### EXAMPLE 11

### G2243/W

A—Prepolymer of DOPOFORM, EXOLIT PE110, Bisphenol-A-diglycidyl Ether (BADGE) und Rubber (Hycar 1300×13)

0.05 mol DOPOFORM and 0.05 mol PE110 are mixed in a 100 ml beaker heated in an oil bath (170° C.) to obtain a clear mixture. 0.327 mol BADGE and 4.34 g rubber are weighed in and admixed under stirring. The resulting clear mixture is then heated for further 30 min.

B—Duromer production (curing with dicyandiamide)

The mixture is removed from the bath and degassed for 10 min. 5.065 g (6 parts by weight) dicyandiamide and 1.688 g (2 parts by weight) accelerator UR 300 are then added under heating in the oil bath (150° C.), and stirred in with a wooden rod. Subsequently, the mixture is homogenized for 5 min with an ultrasonic probe. The hot mixture is immediately poured into a casting mould preheated to 90° C., which is then placed in a warming cabinet with circulating air. Curing is then carried out according to the following temperature program:

| | | | |
|---|---|---|---|
| | 90° C. | 15 | h |
| | 110° C. | 1.5 | h |
| 110-> | 120° C. | 30 | min |
| | 120° C. | 1 | h |
| 120-> | 140° C. | 30 | min |
| | 140° C. | 1 | h |
| 140-> | 160° C. | 30 | min |
| | 160° C. | ? | h |

The duromer is golden yellow and cloudy.

### EXAMPLE 12

### G2246/2

A—Prepolymer of DOPOFORM, Bisphenol A Diglycidyl Ether (BADGE) and Rubber (Hycar 1300×13)

9.26 g (15%) rubber are dissolved in 0.05 mol BADGE in a 100 ml beaker heated in an oil bath (170° C.) with stirring to obtain a clear mixture. 0.05 mol DOPOFORM are added portionwise and dissolved. The mixture remains clear. The mixture is removed from the bath. It is left to cool to 127° C. and 5 mmol 3-dimethylamino-1-propylamine are then added under vigorous stirring, which results in some clouding of the mixture. After the exothermic reaction (temperature in the reaction vessel increases to 137° C.) has ceased, the mixture is further heated in the oil bath (170° C.) for 2 h. The product is cloudy, highly viscous, and hard and brittle at room temperature.

B—Duromer Production (Curing with Diaminodiphenyl Sulfone)

The prepolymer is mixed with 31.6 g (50% of the total mixture) BADGE under heating in the oil bath (140° C.) (the mixture is clear) and then degassed for 10 min. 18.22 g diaminodiphenyl sulfone are then added over 12 min and the mixture degassed again for 5 min.

The hot mixture is immediately poured into a casting mould preheated to 110° C., which is then placed in a warming cabinet with circulating air. Curing is then carried out according to the following temperature program:

| | | | |
|---|---|---|---|
| | 110° C. | 5 | h |
| 110-> | 120° C. | 30 | min |
| | 120° C. | 4 | h |
| 120-> | 140° C. | 30 | min |
| | 160° C. | 1 | h |
| 160-> | 180° C. | 30 | min |
| | 180° C. | 1 | h |

The duromer is golden yellow and milky.

### EXAMPLE 13

### G2247

A—Prepolymer of DOPOFORM, Bisphenol A Diglycidyl Ether (BADGE) and Rubber (Nipol 1472×)

In a 100 ml beaker, 1.544 g (5%) rubber are dissolved in 1.6 g methyl ethyl ketone (MEK) and mixed with 0.05 mol BADGE under stirring to obtain a not completely clear mixture. The solvent is removed by heating in the oil bath (170° C.) for 5 min and the remaining mixture is subsequently degassed for 5 min. 0.05 mmol DOPOFORM are added portionwise and dissolved. The mixture remains almost clear.

The mixture is removed from the bath. It is left to cool to 120° C., and 5 mmol 3-dimethylamino-1-propylamine are then added under vigorous stirring, which results in clouding of the mixture. After the exothermic reaction (temperature in the reaction vessel increases to 130° C.) has ceased, the mixture is further heated in the oil bath (170° C.) for 2 h. The product is cloudy and viscous.

B—Duromer Production (Curing with Diaminodiphenyl Sulfone)

The still hot prepolymer is mixed with 32.55 g (50% of the total mixture) BADGE under heating in the oil bath (150° C.) (the mixture is almost clear) and then degassed for 12 min. 13.97 g diaminodiphenyl sulfone are then added portionwise over 12 min and the mixture degassed again for 5 min. The hot mixture is immediately poured into a casting mould preheated to 110° C., which is then placed in a warming cabinet with circulating air. Curing is then carried out according to the following temperature program:

| | | | |
|---|---|---|---|
| | 110° C. | 5 | h |
| 110-> | 120° C. | 30 | min |
| | 160° C. | 1 | h |
| 160-> | 180° C. | 30 | min |
| | 180° C. | 1 | h |

The duromer is golden yellow and milky.

### EXAMPLE 14

### G2235

A—Prepolymer of DOPOFORM, Bisphenol A Diglycidyl Ether (BADGE)

0.05 mol DOPOFORM are dissolved in 0.05 mol BADGE in a 150 ml beaker heated in an oil bath (170° C.) with stirring to obtain a clear mixture.

The mixture is removed from the bath. It is left to cool to 124° C. and 0.005 mol 3-dimethylamino-1-propylamine are then added under vigorous stirring. After the exothermic reaction (temperature in the reaction vessel increases to 140° C.) has ceased, the mixture is further heated in the oil bath (170° C.) for 2 h. (Temperature of the mixture 150-160° C.). The mixture is subsequently degassed for 1 h.

B—Duromer Production (Curing with Dicyandiamide)

The still hot prepolymer is mixed with 31.4 g (50% of the total mixture) BADGE under heating in the oil bath (150° C.) (the mixture remains clear) and then degassed for approx. 15 min. The mixture is allowed to cool to 90° C., and 3.705 g (6 parts by weight) DiCy and 1.235 g (2 parts by weight) UR 300 are then stirred in. The mixture is subsequently degassed again for 5 min. The hot cloudy mixture is immediately poured into a casting mould preheated to 90° C., which is then placed in a warming cabinet with circulating air. Curing is then carried out according to the following temperature program:

| | | | |
|---|---|---|---|
| | 90° C. | 17 | h |
| | 110° C. | 1.5 | h |
| 110-> | 120° C. | 30 | min |
| | 120° C. | 1 | h |
| 120-> | 140° C. | 30 | min |
| | 140° C. | 1 | h |
| | 140° C. | 1 | h |
| 140-> | 160° C. | 30 | min |
| | 160° C. | 1 | h |

The duromer is golden yellow and cloudy.

### EXAMPLE 15

### G2236

A—Prepolymer of DOPOFORM, Bisphenol A Diglycidyl Ether (BADGE) and Rubber (Hycar 1300×13)

4.63 g (15%) rubber are dissolved in 0.05 mol BADGE in a 150 ml beaker heated in an oil bath (170° C.) with stirring to obtain a clear mixture. 0.05 mol DOPOFORM are added portionwise and dissolved. The mixture remained clear. The mixture is removed from the bath. It is left to cool to 127° C., and 5 mmol 3-dimethylamino-1-propylamine are then added under vigorous stirring, which results in some clouding of the mixture. After the exothermic reaction (temperature in the reaction vessel increases to 137° C.) has ceased, the mixture is further heated in the oil bath (170° C.) for 2 h (temperature of the mixture 168-170° C.). The product is cloudy, viscous and hard at room temperature.

B—Duromer Production (Curing with Dicyandiamide)

The still hot prepolymer is mixed with 36.0 g (50% of the total mixture) BADGE under heating in the oil bath (150° C.) (the mixture becomes clear) and then degassed for approx. 15 min. The mixture is allowed to cool to 90° C., and 4.321 g (6 parts by weight) DiCy and 1.440 g (2 parts by weight) UR 300 are then stirred in. The mixture is subsequently degassed again for 5 min. The hot cloudy mixture is immediately poured into a casting mould preheated to 90° C., which is then placed in a warming cabinet with circulating air. Curing is then carried out according to the following temperature program:

| | | | |
|---|---|---|---|
| | 90° C. | 16 | h |
| | 110° C. | 1.5 | h |
| 110-> | 120° C. | 30 | min |
| | 120° C. | 1 | h |
| 120-> | 140° C. | 30 | min |
| | 140° C. | 1 | h |
| 140-> | 160° C. | 30 | min |
| | 160° C. | 1 | h |

The duromer is golden yellow and cloudy.

### EXAMPLE 16

### G2247

A—Prepolymer of DOPOFORM, Bisphenol A Diglycidyl Ether (BADGE) and Rubber (Nipol 1472×)

0.05 mol BADGE are dissolved in 3.088 g (equivalent to 5%) of a 50% rubber solution (in MEK) in a 150 ml beaker with stirring, to obtain an almost clear mixture. The solvent is evaporated by heating in an oil bath (170° C.) for 5 min and the solution is subsequently degassed for 5 min. 0.05 mol DOPOFORM are added portionwise and dissolved. The mixture is not completely clear. The mixture is removed from the bath. It is left to cool to 120° C., and 5 mmol 3-dimethylamino-1-propylamine are then added under vigorous stirring, which results in clouding of the mixture. After the exothermic reaction (temperature in the reaction vessel increases to 130° C.) has ceased, the mixture is further heated in the oil bath (170° C.) for 2 h (temperature of the mixture 165-170° C.).

B—Duromer Production (Curing with Diaminodiphenyl Sulfone)

The still hot prepolymer is mixed with 32.55 g (50% of the total mixture) BADGE under heating in the oil bath (150° C.) (the mixture becomes almost clear) and then degassed for approx. 12 min. 13.967 g DDS (0.225 eq NH) are stirred in portionwise (temperature of the mixture 140° C.). The mixture is subsequently degassed again for 5 min. The hot mixture is immediately poured into a casting mould preheated to 110° C., which is then placed in a warming cabinet with circulating air. Curing is then carried out according to the following temperature program:

| | | | |
|---|---|---|---|
| | 110° C. | 5 | h |
| 110-> | 120° C. | 30 | min |
| | 120° C. | 3 | h |
| 120-> | 140° C. | 30 | min |
| | 140° C. | 1 | h |
| 140-> | 160° C. | 30 | min |
| | 160° C. | 1 | h |
| 160-> | 180° C. | 30 | min |
| | 180° C. | 1 | h |

The duromer is golden yellow and milky.

### EXAMPLE 17

### Formulation of Repair Resins

Plates, laminates and prepregs were produced from different epoxy resin mixtures for use as repair resins and their properties analyzed. For this, TETA (triethylenetetramine) was used as curing agent and DMAPA (3-dimethylamino-1-propylamine) was used as catalyst (accelerator) (5 mol % of the EP groups).

Preparation of the Resin Mixture

DOPO-EP6 was dissolved in the diluent Polypox R16 in a 1:3 ratio under heating in an oil bath (150° C.) and evacuated for degassing for 30 min. The clear mixture was cooled to 15-20° C. with ice water. The curing agent (ratio EP mixture:curing agent 1:1) and accelerator were added to this mixture and thoroughly stirred, while maintaining the cooling. The mixture should be stirred repeatedly and left in the ice water. The processing time was approx. 30 min.

Plate

The resin mixture was poured into a standing, top open aluminum casting mould (W×H×D/16×9×0.6 cm) and cured at room temperature for approx. 24 h.

Laminate

9 strips of fiber glass fabric (7781) were cut to a size of 2×13 cm. The first strip was laid on a separating foil and coated with the resin mixture. The second strip was then laid on top of that, pressed on slightly, and coated with the resin mixture. This procedure was repeated with the remaining strips. No resin was coated on the last strip. The laminate was covered with separating foil and cured at room temperature for approx. 24 h.

Prepreg

A piece of fiber glass fabric (12×12 cm) was laid on a separating foil and coated with the resin mixture, excess resin being wiped off. The prepreg was covered with separating foil and cured at room temperature for 24 h. P content: 1.37%

The MARHE value for the Prepreg (44% resin content) was 20 kW/m² as measured with a Cone calorimeter at 50 kW/m².

MARHE=Maximum Average Rate of Heat Emission, i.e. maximum value of the running average heat emission rate after the start of the experiment t=0

COₜₒₜₐₗ was 1 ppm; HRRtotal: 70 kW/m²
coₜₒₜₐₗ=average CO smoke gas concentration from t_{ignition} to t_{Flameout}
HRRₜₒₜₐₗ=average heat emission rate of from t_{ignition} to t_{Flameout},
wherein t_{ignition}=time until ignition
t_{FlameOut}=time until the end of the effective combustion
   The measured values confirm the good flame resistance of the Prepreg.

### EXAMPLE 18

A resin mixture was prepared analogously to example 17, with the difference that DOPO-EP5 1:3 was dissolved in the same diluent and the ratio of epoxy resin mixture (DOPO-EP5+diluent) to curing agent was 2:1.

The respective products (plate, laminate or prepreg) were cured at room temperature for 48 h. The P content of the polymer resin was 1.57%.

The elasticity module of the laminate (47% resin content) was 16,500 MPa; K_{rc}: 0.7 MN/m²; max. bending stress: 385 MPa The MARHE-WERT of the prepreg was 31 kW/m²; Coₜₒₜₐₗ was 16 ppm.

The measured values confirm the good flame resistance of the Prepreg.

### EXAMPLE 19

### Preparation of an Impregnating Mixture

1. Preparation of the P-containing Rubber-modified Epoxy Prepolymer DD1K1

DOPOFORM and BADGE at a mole ratio of 1:1 are used for producing the phosphorous-containing epoxy prepolymer DD1K1. Further, 5 mol % of DMAPA, with respect to the epoxy groups of BADGE, and 10 ma % (mass percent) of CTBN×13, with respect to the total weight of DOPOFORM, BADGE and DMAPA, are used. BADGE and CTBN×13 are weighed into a three-necked flask equipped with stirrer, (+stirring unit), internal thermometer and dropping funnel, heated to 150° C., and mixed with stirring. The mixture is subsequently heated to 170° C. and DOPOFORM added under stirring. Upon obtaining a clear mixture, it is allowed to cool to 150° C., and DMAPA is slowly added dropwise. The dropwise addition should take place slowly due to the associated exothermic reaction. Upon completing the addition, the mixture is again heated to 170° C. and stirred for one hour. The mixture is cooled down by pouring it on aluminum foil.

2. Preparation of the Impregnation Solution

The impregnation solution is prepared using the cyanate resin PRIMASET PT15 (a product of the company Lonza), DD1K1, Co(acac)₂ in TGPAP, and Exolit OP 930 in the mass ratios of 57.7:31.7:1.08:9.5. The mass percentages of the catalyst Co(acac)₂ in TGPAP are, in turn, divided up into 40 ma % Co(acac)₂ and 60 ma % TGPAP.

The substances PT15 and DD1K1 are each dissolved completely in MEK and then mixed together. Co(acac)₂ is dissolved for 2 h at 80° C. in TGPAP and subsequently added, together with the Exolit, to the above solution. The mixture is then stirred with a stirrer (stirring unit) to obtain a homogeneous mixture. The solvent fraction should be approx. 40 ma %.

This solution was used to conduct impregnations with fiber glass fabric. The impregnation capacity was very good. The prepregs presented a uniform application of resin without agglomerations. After storing for 24 hours at room temperature, a tack of 2− was determined, which could be increased to tack 2+ by activation with isopropanol. A 6-layer laminate was produced by pressing at 135° C./30 min, and the curing determined by DMA using the 3-point bending bench (1. Run=157° C., 2. Run=171° C.). In addition, a sandwich panel with a honeycomb core was produced using the crushed core method with a curing time of 30 min at 135° C. It presented a very good surface quality, a peel value of 25.76 N and an HRR value of 190.6 kW/m² (at 50 kW/m² heat irradiation).

### EXAMPLE 20

### Preparation of a UP Resin Prepolymer

In a 2 l flask equipped with stirrer, water separator, thermometer, reflux condenser, and nitrogen purge, 29.6 g (0.2 mol) phthalic acid anhydride, 19.6 g (0.2 mol) maleic acid anhydride, 15.2 g (0.2 mol) propylenglycol, 49.2 g (0.2 mol) DOPOFORM, 43.4 g (0.1 mol) DOPO itaconic acid bis(2-hydroxyethyl) ester, 20 g xylene, and 50 mg hydroquinone are heated to 100° C. with stirring and under a stream of nitrogen. The heater is removed at the onset of the exothermic reaction (the temperature rises up to approx. 150° C.). After the reaction has ceased, stirring is continued at approx. 190° C., further xylene being added, if required. After separation of approx. 14 ml of water, the xylene is distilled off under a vigorous stream of nitrogen, the remaining polyester melt is allowed to cool to 150° C. and poured into a storage container. The product was tough and viscous after cooling down. With 143 g, the yield was practically 100%.

### EXAMPLE 21

### Preparation of a Phenol Resin Prepolymer

In a glass flask equipped with stirrer and distilling column, 94 g (1 mol) phenol, 81 g of 37% formaldehyde solution (1 mol) and 9.3 g (0.65 mol) hexamethylenetetramine were heated to 80° C. under stirring. To this, 24.6 g (0.1 mol) DOPOFORM were slowly added and the condensation continued for 1.5 h at 80° C. The volatile components were subsequently distilled off under vacuum at a maximum sump temperature of 95° C. The remaining resin melt was rapidly poured on a glass plate for cooling purposes. The yield was 129 g of a yellow brown solid resol.

### EXAMPLE 22

### Preparation of Compound Ie by Cyanation of DOPOFORM

5 mmol DOPOFORM are pulverized in an impact mill and suspended in a solution of 5.5 mmol bromine cyanide in 10 ml chloroform.

5 mmol triethylamine (in 1.5 ml chloroform) are added dropwise during 6 min at 2-6° C. (ice bath). The reaction mixture is transferred to a separating funnel and washed with water three times (still undissolved starting substance DOPOFORM collects at the phase boundary). The chloroform phase is dried for 45 min over phosphorous pentoxide and concentrated in a rotary evaporator at 35° C. until dry. The solid residue is washed three times with isopropanol.

A white crystalline product is obtained; melting point 130° C.; yield 55-60%.

### EXAMPLE 23

### Preparation of Compound If by Reaction of DOPOFORM with Cyanuric Chloride

0.02 mol cyanuric chloride are added to 40 ml chloroform. 0.07 mol DOPOFORM are dissolved in 110 ml pyridine and slowly added dropwise at 3-8° C. (ice bath). The heat generation is completed after adding about 80 ml of the DOPOFORM solution. After completing the addition, the mixture is subsequently stirred for further 1.5 h. The reaction mixture is transferred to a separating funnel and washed three times with 700 ml of water each. The chloroform phase is dried with sodium sulfate over night and concentrated in a rotary evaporator at 40° C. until reaching mass constancy. The liquid residue is precipitated by adding it dropwise to 150 ml. After the flocculent product has settled, it deliquesces into a sticky mass. After decanting, the product is dried with circulating air at 40° C.

1. A prepolymer with a GPC determined average molecular weight Mn in the range of 200-10,000 and an average molecular weight Mw in the range of 400-30,000, obtained by reacting at least one phosphinic acid derivative of formula I
(R¹O)(R²)P(O)—R³,
wherein R¹ and R² independently of one another represent an optionally substituted alkyl, aryl, arylalkyl, alkylaryl or alkylarylalkyl group with 1 to 20 carbon atoms,
R³ represents hydrogen or an optionally substituted alkyl, aryl, arylalkyl, alkylaryl or alkylarylalkyl group with 1 to 20 carbon atoms,
with at least one resin selected from the group consisting of an epoxy resin, cyanate resin, an unsaturated polyester, vinyl ester, phenol resin, and a bismaleimide.

2. The prepolymer according to claim 1, wherein the phosphinic acid derivative of formula I the carbon atoms of the groups represented by R¹ and R² are bonded to one another.

3. The prepolymer according to claim 2, wherein the phosphinic acid derivative of formula I the group (R¹O)(R²)P(O)— represents an intramolecular anhydride of an alkane phosphinic acid with a terminal carboxyl group.

4. The prepolymer according to claim 2, wherein the phosphinic acid derivative of formula I the group ((R¹O)(R²)P(O)— represents a derivative of 1:9,10-dihydro-9-oxa-10-phosphaphenanthrene-10-oxide (DOPO).

5. The prepolymer according to claim 1, wherein the phosphinic acid derivative of formula I the group R³ contains at least one functional group, which is capable to react with a functional group of the resins as described in claim 1.

6. The prepolymer according to claim 5, wherein the functional group is selected from the group consisting of a hydroxyl group, ether group, thioether group, an optionally substituted carboxylic acid group, cyanate group, and a maleimide group.

7. The prepolymer according to claim 1, wherein at least one phosphinic acid derivative is selected from compounds of the following structural formulas:

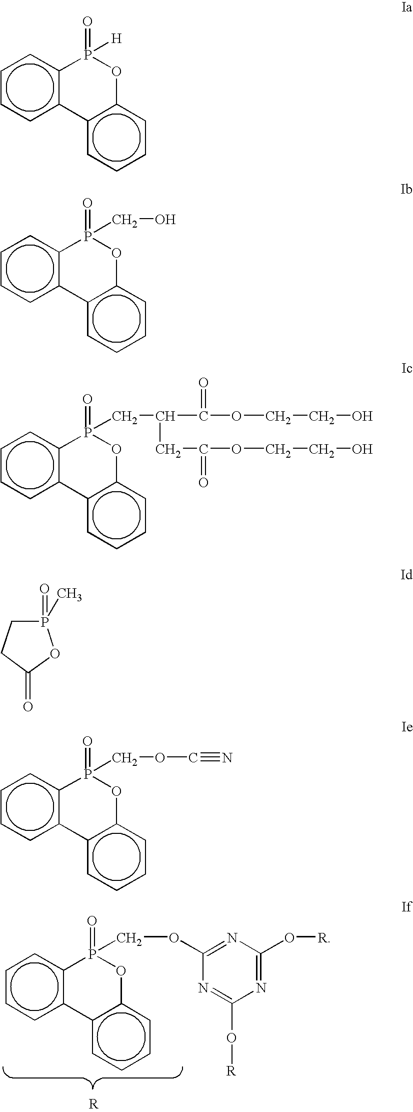

8. The prepolymer according to claim 1, further comprising at least one toughness modifier.

9. The prepolymer according to claim 8, wherein the toughness modifier is incorporated into the prepolymer covalently.

10. The prepolymer according to claim 8, wherein the toughness modifier is selected from the group consisting of rubbers, core-shell particles, thermoplastic silicone elastomers, elastomers, siloxanes and polyethers.

11. A phosphinic acid derivative having the structural formula Ie or If

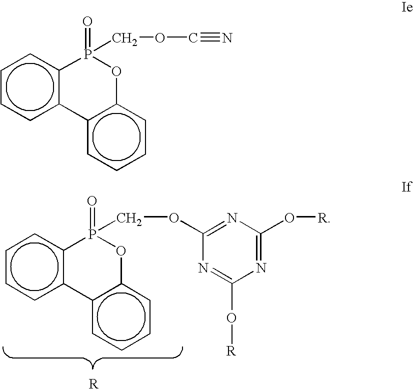

12. The use of the prepolymer according to claim 1 for producing a flame resistant polymer.

13. The use according to claim 12, wherein that a curing agent is used in the production of the flame resistant polymer.

14. The use according to claim 13, wherein p-xylenediamine, triethylenetetramine, dicyandiamide or diaminodiphenyl sulfone is used as curing agent.

15. The use according to claim 12, wherein a catalyst is used in the production of the flame resistant polymer.

16. The use according to claim 15, wherein 3-dimethylamino-1-propylamine (DMAPA), triethanolamine, benzyldimethylamine (BDMA), an imidazole derivative or diazabicycloundecane (DBU) is used as catalyst.

17. The use according to claim 13, wherein the curing agent or catalyst are used in encapsulated form and the point in time for the curing agent or catalyst to participate in the conversion is adjustable by controlled release thereof from the capsules.

18. The use according to claim 12, wherein a reactive diluent is used in the production of the flame resistant polymer.

19. The use according to claim 18, wherein a compound selected from the group comprising bis(3-glycidyloxypropyl)tetramethyl disiloxane, triglycidyl-p-aminophenol, cyclohexanedimethanol diglycidyl ether, glycerin triglycidyl ether, neopentyl glycol diglycidyl ether, pentaerythritol tetraglycidyl ether, polypropylene glycol diglycidyl ether and trimethylolpropane triglycidyl ether is used as reactive diluent.

20. The use according to claim 12, wherein further additives or fillers are incorporated into the flame resistant polymer.

21. The use according to claim 12, wherein thermal curing, UV curing or electron beam curing is carried out in the production of the flame resistant polymer.

22. The use of the prepolymer according to claim 1 or of a resin composition comprising said prepolymer for producing a molded article, laminate or prepreg or a coating, or the use thereof as an adhesive or repair resin.

23. A flame resistant polymer produced using a prepolymer according to claim 1 or a phosphinic acid derivative according to claim 11.

24. The flame resistant polymer according to claim 23, wherein the phosphorous content of the polymer is less than 3%.

25. The flame resistant polymer according to claim 23, wherein the flame resistant polymer is duromer.

26. The use according to claim 12, wherein the flame resistant polymer is duromer.
